(19) United States
(12) Patent Application Publication
(10) Pub. No.: US 2015/0120777 A1
(43) Pub. Date: Apr. 30, 2015

(54) System and Method for Mining Data Using Haptic Feedback

(71) Applicant: Olivia Ramos, Miami Beach, FL (US)

(72) Inventor: Olivia Ramos, Miami Beach, FL (US)

(21) Appl. No.: 14/523,313

(22) Filed: Oct. 24, 2014

Related U.S. Application Data
(60) Provisional application No. 61/895,031, filed on Oct. 24, 2013.

(51) Int. Cl. G06F 17/30; G06F 3/01

(52) U.S. Cl. CPC G06F 17/30572; G06F 17/30525; G06F 3/016
USPC 707/776

(57) ABSTRACT

Data from at least one outside data source containing Big Data is translated into a virtual three-dimensional object that identifies data of interest. In an embodiment, the data is translated into a tactile three-dimensional object that can be felt, for example, with a haptic controller. Embodiments allow for navigation, mining, and structuring of the data, as well as facilitating real time analysis of the data.

### CROSS REFERENCE TO RELATED APPLICATIONS

This application claims the benefit of U.S. Provisional App. No. 61/895,031 filed Oct. 24, 2013, which is hereby incorporated by reference in its entirety.

### BACKGROUND

1. Technical Field

Embodiments are directed to processing and analyzing Big Data data sets. More particularly, embodiments relate to providing visualization of Big Data data sets as a three-dimensional object, and allowing haptic interaction with the three-dimensional object to facilitate analyzing the Big Data data sets.

2. Background

Generally, Big Data refers to data sets that are too large and complex to be handled using conventional data processing systems and applications. Big Data is sometimes defined in terms of “volume,” “velocity,” and “variability.” Volume refers to the vast amounts of data. Velocity refers to the speed at which the data is presented to a processing application. Variability refers to the different formats in which the data may exist.

Attempts to process Big Data data sets can be traced to at least as early as 1962, and involved text recognition using an early IBM computer called “Stretch Harvest.” In a period of 3 hours and 50 minutes, “Stretch Harvest” scanned 7 million 500-character messages to mine for 7,000 different words or phrases of interest. Detected information, or information responsive to the queries was output visually. (See, Lohr, S. “Big Data Sleuthing, 1960s Style”. New York Times. (Jun. 10, 2013), <http://bits.blogs.nytimes.com/2013/06/10/big-data-intelligence-sleuthing-1960s-style/?_php=true&_type=blogs&_php=true&_type=blogs&_r=1>), which is incorporated by reference herein in its entirety.

In the years following, big data grew exponentially into all facets of modern life. For example, in 2012, Google processed over 20 petabytes, that is, nearly 21 million gigabytes, of data per day. (See, Gallagher, Sean. “The Great Disk Drive in the Sky: How web giants store—big and we mean big—data.” ArsTechnica.com <http://ArsTechnica.com>. (Jan. 26, 2012), <http://arstechnica.com/business/2012/01/the-big-disk-drive-in-the-sky-how-the-giants-of-the-web-store-big-data/>), which is incorporated by reference herein in its entirety.

The U.S. Department of Defense is faced with processing similarly vast amounts of data. For instance, the National Security Agency, (“NSA”) collects information provided by telephone companies pertaining to millions of phone calls. NSA uses audio output to analyze these calls. (See, Cauley, Leslie. “NSA has massive database of American's phone calls.” USAToday.com <htttp://USAToday.com>. (May 11, 2006), http://usatoday30.usatoday.com/news/washington/2006-05-10-nsa_x.htm), which is incorporated by reference herein in its entirety. Reliance on audio output makes it virtually impossible to timely correlate the information from all of the calls in a meaningful way to discover important relationships that may exist between the calls.

In addition, NSA and the Federal Bureau of Investigation (“FBI”) access the central servers of leading U.S. Internet companies to process 1.5 gigabytes of packet data per second. These agencies face major problems with storing, indexing, and analyzing these enormous quantities of data. (See, Gellman, Barton and Poitras, Laura. “U.S., British intelligence mining data from nine U.S. Internet companies in broad secret program.” WashingtonPost.com http://WashingtonPost.com (Jun. 7, 2013), <http://www.washingtonpost.com/investigations/us-intelligence-mining-data-from-nine-us-internet-companies-in-broad-secret-program/2013/06/06/3a0c0da8-cebf-11e2-8845-d970ccb04497_story.html>), which is incorporated herein by reference in its entirety. In fact, how to handle these big data issues led DARPA to host its first Innovation House with a focus on Big Data in 2012. (See, DARPA, Life at DARPA, Innovation House Begins, DARPA, (Sep. 28, 2012), <http://www.darpa.mil/NewsEvents/Releases/2011/09/28.aspx>), which is incorporated by reference herein in its entirety.

There are several reasons why conventional methods of data navigation and structuring have not kept pace with the speed and scale required for processing Big Data data sets. One problem is that conventional methods for handling Big Data rely on rudimentary visual outputs for individual analysts to synthesize the data. However, given individual analysts have only a few minutes of concentration time, with a maximum of five parallel points of focus, such rudimentary visual outputs severely test the limits of individual data analysts' ability to process the visual information. (See, Pylyshyn, Z. W., & Storm, R. W. “Tracking multiple independent targets: Evidence for a parallel tracking mechanism”. Spatial Vision, 3, 179-197. (1988)), which is incorporated by reference herein in its entirety. Another problem is conventional systems and applications provide limited navigation options and limited ability to rapidly structure data. Thus, it is required to provide a system to facilitate processing and analyzing Big Data data sets.

Studies have shown that by combining vision with touch, and therefore having two different encoding pathways to the brain for the same subject, analysts are able to better distinguish data of interest from other data. (See, Klatzky, R. L. & Lederman, S. “There's more to touch than meets the eye: The salience of object attributes for haptics with and without vision”. Journal of Experimental Psychology Vol, 116, No 4, 356-369 (1987)), which is incorporated by reference herein in its entirety. Tactile transmission of information can be traced back to the 1821 Night Writing code that used twelve raised dots to allow soldiers to share top-secret information on the battlefield without having to speak. Louis Braille used this concept to publish the first Braille book in 1829. In 1868, the Royal National Institute for the Blind spread Braille worldwide. (See, American Foundation for the Blind: “Louis Braille Biography”. Braille Big. (2011), <http://braillebug.afb.org/louis_braille_bio.asp>), which is incorporated by reference herein in its entirety.

Haptic technology allows the use of touch to manipulate virtual objects. Haptic technology has grown in popularity since 2002, with the Rutgers Master II, a force-feedback glove with a haptic interface that was designed for dexterous interactions with virtual environments.

These and other problems associated with processing and analyzing Big Data data sets are solved by embodiments of the present invention.

### SUMMARY

In an embodiment, initial queries are created via a human user interface or automatically via an application program interface (“API”) to filter, extract, and store data from one or more outside Big Data data sources. In an embodiment, the filtering, extraction, and storing is performed by a custom search algorithm (“CSA”). In an embodiment, the CSAs perform the searches using keywords and/or strings. The keywords and/or strings can be input by an analyst or generated automatically through a computer API.

In an embodiment, the data retrieved from the outside Big Data data sources is stored in a local data storage along with annotations that describe the data. The annotations may be pre-existing annotations stored in the outside data sources, annotations generated by the CSAs and/or, annotations input by analysts. In an embodiment, annotations are linked to corresponding data stored in the local data storage.

After the data is stored locally, additional queries can be applied against the data to further narrow data responsive to a particular query. In an embodiment, the additional queries can be created through a human user interface.

In an embodiment, data stored in the local data storage is represented in a graphical construct that is displayed to the analyst. In an embodiment, the graphical construct displays the data so as to show its relevance to a particular query, that is, how well the data matches the query.

In an embodiment, the graphical construct is a virtual three-dimensional representation of the data corresponding to the data in the local data storage. For example, where the three-dimensional object is spherical, the virtual three-dimensional object is referred to as a haptic sphere. In an embodiment, the haptic sphere is divided into subdivisions, wherein each subdivision corresponds to a unique piece of data in the local data storage. In an embodiment, data of interest can be selected. For example, a unique piece of data can be selected by selecting a particular subdivision. Selecting the subdivision presents to the analyst the locally stored version of the original data underlying the subdivision.

In an embodiment, extrusions of varying sizes and shapes represent relevance of the data to the query. For example, a longer extrusion may represent greater relevance than a shorter extrusion. Other ways of distinguishing data, such as color, can be used in lieu of or in addition to extrusions. In an embodiment, the extrusions change in real time in response to the corresponding relevance of queries against the local data storage. The immediacy for this type of solution to structuring and navigating large data repositories from multiple outside data sources is apparent in most every industry.

In an embodiment, a panhaptic interface provides a multi-sensory approach for Big Data data set analysis by calibrating a haptic controller to interact with the haptic sphere that represent a given data repository. Such interaction can include manipulation, for example, rotation, and tactile feedback such that the user can feel differences in the haptic sphere that provides information as to the underlying data.

Thus, in operation, an analyst's hand “feels” the data that is represented by extrusions in the virtual object. As a result, the analyst's eyes are free to focus on more refined information such as the original source of the data. The extrusions function as a simple language, represented by such features as length, girth, and sharpness of the extrusion. Tactile feedback leverages vision to allow the user's eyes to focus on high-level qualitative data, and allow the user to qualify data of interest faster than is possible using conventional data navigation tools. Increasing human memory recall and broadening the scope of information intake, the panhaptic interface's tactile and visual feedback function offers a very promising sensory activator.

Additional features and embodiments of the present invention will be evident in view of the following detailed description of the invention.

### BRIEF DESCRIPTION OF THE DRAWINGS

FIG. 1 is a schematic diagram of an architecture for processing data from one or more Big Data data sources according to an embodiment of the present invention.

FIG. 2 illustrates an exemplary virtual three-dimensional object representing a data repository that shows subdivisions according to an embodiment of the present invention.

FIG. 3 illustrates an exemplary virtual three-dimensional object representing a data repository that show extrusions that assist a user in understanding the data according to an embodiment of the present invention.

FIG. 4 illustrates an exemplary upload interface for entering keywords or strings to retrieve and structure external data from multiple outside data sources and haptically interact with a virtual three-dimensional object representation of the retrieved data according to an embodiment of the present invention.

FIG. 5 illustrates an exemplary navigation interface for entering keywords or strings to retrieve, refine, and structure, data from the local data storage and haptically interact with a virtual three-dimensional object representation of the refined data according to an embodiment of the present invention.

FIG. 6 illustrates an exemplary archive interface for archiving refined and structured data, combine archived data, and cross examine data using the virtual three-dimensional object representation of the archived data according to an embodiment of the present invention.

FIG. 7 illustrates an exemplary human interface for modifying parameters to generate extrusions in the three-dimensional object.

FIG. 8 is a schematic diagram of a haptic glove according to an embodiment of the present invention.

FIG. 9 is a flow chart for a method for mining data using haptic feedback according to an embodiment of the present invention.

FIG. 10 is a schematic diagram of an exemplary environment for mining data using haptic feedback according to embodiment of the present invention.

### DETAILED DESCRIPTION OF EXEMPLARY EMBODIMENTS

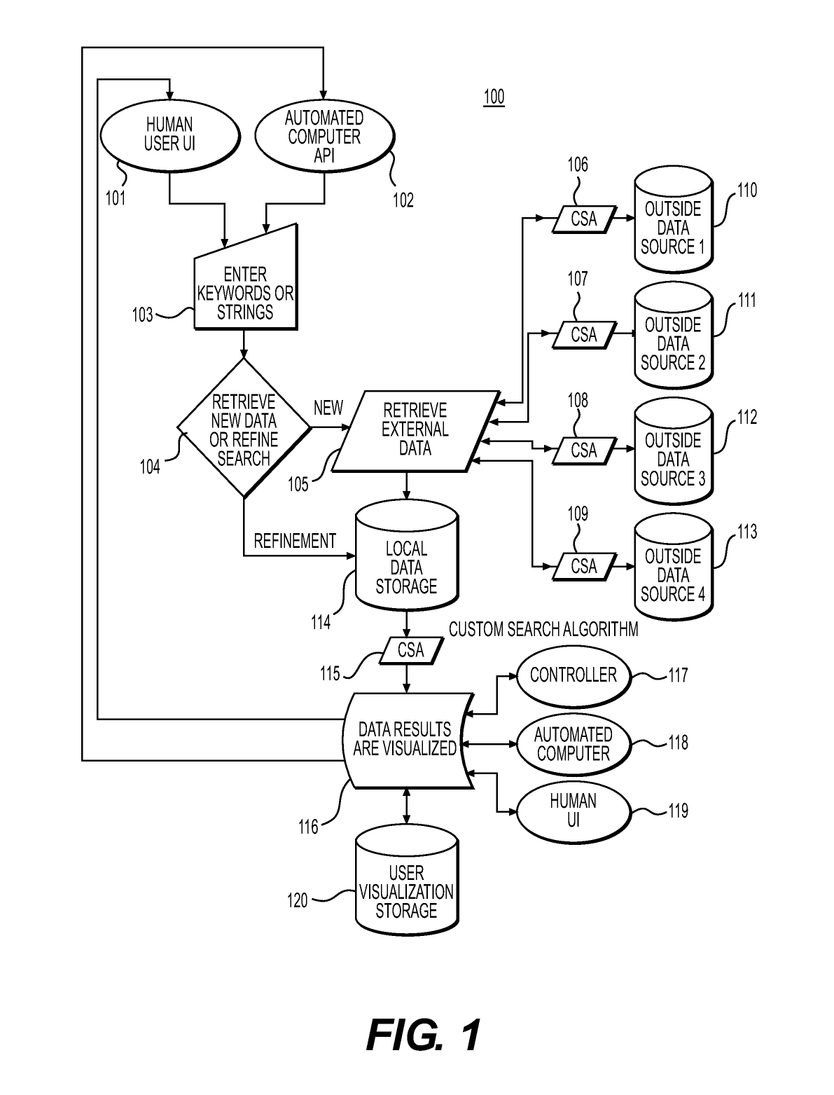

FIG. 1 is a schematic diagram of an architecture 100 for accessing one or more Big Data data sources and mining (including, e.g., extracting and analyzing) data therein according to an embodiment of the present invention. Architecture 100 includes a human user interface 101 through which an analyst or user (analyst and user are used interchangeably throughout) can enter keywords and/or strings to query one or more outside data sources 110-113. Entry of search terms, such as keywords and/or strings can be through any appropriate input device such as a keyboard or voice recognition device 103. A determination is made by module 104 as to whether the query is a new query of outside data sources 110-113 or a query to refine a pervious query. For a new query, a module 105 controls retrieving data from outside data sources 110-113. To refine a previous query, the query is applied to a local data storage 114 that stores data retrieved from outside data sources 110-113. In an embodiment, an automated computer API 102 can generate queries to outside data sources 110-113. In an embodiment, one or more of outside data sources 110-113 contain Big Data data sets. A piece of data stored in data sources 110-113 is termed a “data element.” For example, in where a data source stores images, each image in the data source is a data element.

Architecture 100 includes one or more custom search algorithms, for example, (“CSAs”) 106-109. CSAs 106-109 apply the analyst or automated computer API-generated queries to retrieve data of interest from outside data sources 110-113. In an embodiment, the queries are based on annotations. In an embodiment, module 105 coordinates CSAs 106-109.

Annotations are symbols or attributes that provide value to or further describe a particular data element stored in outside data sources 110-113. Exemplary annotations include, for example, and without limitation, location, time, actions, colors, and measurements. Annotations can take a number of forms, including notes or text describing the data to which they add value or description as well as content within the data itself. Annotations allow for qualifying, grouping, and otherwise structurally configuring data stored in outside data sources 110-113.

Using the annotations in a particular query, CSAs 106-109 search for matching annotations in outside data sources 110-113. In an embodiment, CSAs 106-109 retrieve data and associated annotations from outside data sources 110-113 responsive to a query. In an embodiment, CSAs 106-109 can automatically generate additional annotations. In an embodiment, CSAs 106-109 provide the analyst with an opportunity to add additional annotations. Any additional annotations are stored along with the data and any annotations retrieved from outside data sources 110-113. Further, additional annotations are assigned unique identifications (IDs) with which they can be matched to one or more data elements in local data storage 114.

In an embodiment, annotations also facilitate data archiving by providing relationships between data elements that share annotations. For example, consider an image database containing an image of an armed robbery and an image of a battlefield. Both images may include an image of a “gun.” As a result each image may have as an accompanying annotation the text “gun.” Thus, the images are related by the annotation “gun.” Thus, if a user queries the image database with the search term “gun,” both the battlefield and armed robbery image, along with the annotation “gun,” are returned in response.

Data responsive to the query and associated annotations, whether pre-existing, or newly generated by a computer API or the analyst, are stored in a local data storage 114. In an embodiment, there may be a custom search algorithm designed for each outside data source 110-113.

In an embodiment, fuzzy logic techniques can be used to find nearly matching annotations in outside data sources 110-113. Where fuzzy logic matches are found, in an embodiment, the annotation(s) used as input to the fuzzy logic algorithms are stored along with data retrieved from outside data sources 110-113.

In an embodiment, the data stored in local data storage 114 is displayed to a user as a graphical representation using a data visualization module 116 that generates the graphical representation. In an embodiment, the graphical representation is a virtual three-dimensional object, for example, a data sphere, referred to herein as a haptic sphere. Architecture 100 includes a human interface 119 to interact with and manipulate the graphical representation. In an embodiment, human interface 101 is used to manually retrieve and structure data from outside data sources 110-113 while human interface 119 is used to manually retrieve and structure data from the local data storage 114. In an embodiment, architecture 100 includes a controller 117 to control interaction and manipulation of data. In an embodiment, controller 117 is an input device such as mouse and/or keyboard or gesture controller. In an embodiment, controller 117 is a haptic controller 117.

Architecture 100 includes an automated computer API 118. Automated computer API 118 exports results into spreadsheets, maps, diagrams or other outputs. In an embodiment, automated computer API 102 is used to automatically retrieve and structure data from outside data sources 110-113, while automated computer API 118 is used to automatically export data into a variety of outputs. A user visualization storage 120 is used to archive structured data, that is data that is responsive to a query along with any annotations thereto.

Outside data sources 110-113 are data storage devices associated with any data repository. Exemplary data repositories include, without limitation, websites, such as Facebook, Twitter, Google, Bing, Yelp, or any other website, data repositories available from the U.S. Government, universities, and other data repositories, or any other source of data. Outside data sources 110-113 can be associated with unrelated organizations. A particular embodiment can have any number of outside data sources.

Outside data sources 110-113 can be any storage device to store data, including, for example, a single storage device, a distributed storage device, an internal storage device or an external storage device. For example, and without limitation, outside data sources 110-113 can be a single storage device on a single computer, a plurality of storage devices maintained in a storage device farm, and/or storage devices distributed over a network, for example, a company intranet, an external network, the Internet, or any other network. Storage devices can comprise one or more hard disks, diskettes, CD-ROMs, DVD, flash drives, or any other storage device for storing data, and can be optical, magnetic, or solid-state, or any other type of data storage.

Outside data sources 110-113 can store various types of data including, without limitation, text, images, videos, and/or frequencies (e.g., sounds) that hold information that may be valuable to an individual or group, or any other type of data. In an embodiment, stored frequencies are those associated with sounds such as sound recordings of conversations or other sound recording, and may be from natural sources such as animal glottal responses or unnatural sources such as traffic collisions. Individual data records stored in outside data sources 110-113 are sometimes referred to as data components or data elements. Data components or data elements can comprise one or more data items.

Outside data sources 110-113 may include pre-existing annotations. For example, where one or more of outside data source 110-113 store images from regions experiencing violent activities, images may have guns, bombs, “EID” (explosive and incendiary device), and the like. As a result text annotations stored along with the images in outside data sources 110-113 may include terms such as “gun” and “EID”. The pre-existing annotations are structured by custom search algorithms 106-109, and stored in local data storage 114. Structuring annotations refers to the CSAs organizing and providing relationships between data elements using annotations, for example, relating data elements through annotation pairing as described in more detail below.

In an embodiment, CSAs 106-109 can be configured to analyze retrieved images to detect items of interest and generate new annotations and annotation categories. For example, where the items of interest are a gun and an EID, CSAs process retrieved images to search for guns or EIDs and then tag those that the CSAs detect as including a representation of a gun or EID retrieved with the annotations gun and/or EID as appropriate. The images along with the new annotations are stored in local data storage 114.

CSAs 106-109 can also be configured to allow analysts to tag images with new annotations, for example, overhead annotations that describe scenarios, research titles, or any other annotation relating to the analyst's investigation. The analysts can query existing annotations or create their own annotations. The tagging of images in local data storage 114 with annotations allows for searching the data through queries directed at the annotations.

Local data storage 114 can be any storage device to store data, including, for example, a single storage device, a distributed storage device, an internal storage device or an external storage device. For example, and without limitation, local data storage 114 can be a single storage device on a single computer, a plurality of storage devices maintained in a storage device farm, and/or storage devices distributed over a network, for example, a company intranet, an external network, the Internet, or any other network. Storage devices can comprise one or more hard disks, diskettes, CD-ROMs, DVD, flash drives, or any other storage device for storing data, and can be optical, magnetic, or solid state, or any other type of data storage. There can be more than one local data storages in a particular embodiment.

In an embodiment, architecture 100 includes additional custom search algorithms 115 to retrieve and structure data within the local data storage 114. Additional CSAs 115 further structure and organize the annotations to facilitate more refined searching. For example, CSAs 115 may analyze existing annotations to restructure the types of data elements retrieved from outside data sources 110-113 and stored in local data storage 114. In an embodiment, this may be accomplished by reviewing original data IDs for the stored data elements. Original data IDs are unique identifications, for example, one-up counter values, associated with each data element stored in a data set. In an embodiment, original data IDs are used to link new annotations to individual data elements stored in the local data storage 114. In an embodiment, annotations structure data by types while original data IDs structure data with numeric values.

In addition, custom search algorithms 106-109, and 115 categorize annotations with overhead annotations or high-level annotations. For example, annotations may be categorized as original data IDs, nouns, verbs, dates, and/or any other category that may apply to a particular data set that is stored in the outside data sources 110-113 as well as any data sets that are stored in local data storage 114. Exemplary nouns include terms such as “gun”, “bomb”, “bag”, “bullet”, “shell casing”, etc. Exemplary verbs include “drop”, “pick up”, “aiming”, “firing”, etc. Exemplary overhead annotations include case numbers, research dates, name of analyst, etc. Any category and value can be used that is appropriate for a particular implementation.

In an embodiment, CSAs can determine annotation values and/or generate new annotation categories to associate with data IDs of data retrieved from outside data sources 110-113. How CSAs accomplish this is scenario-specific. For example, where an outside data source stores images, a CSA uses image processing or computer vision algorithms to identify features of an image. These features are linked to the image ID in the form of annotations. Such features include, without limitation color, verbs/actions, people, weapons, vehicles, time of day, or other features of an image. In another example, where an outside data source stores text, a CSA may employ text and number recognition, for example, a natural language processing algorithm to parse the retrieved data to extract features and characteristics associated with the queried keywords or strings. For frequency recognition, the CSAs may use a signal-processing algorithm to generate digital “fingerprints” of the frequencies (e.g., sounds) or extract other features and characteristics that can be used to generate annotations. These new features of the image, text, and frequency are stored as annotations and linked to the data element's original data ID.

Annotations can also be manually added by an analyst. For example, an analyst can review an image or text or sound and determine an appropriate annotation or annotations for the image, text, or sound.

CSAs 106-109 can execute on any computer that can be configured to access outside data sources 110-113 and run CSAs 106-109 as described herein. Further, CSAs 106-109 and 115 can be one or more processes executing on those computers. In addition, CSAs 106-109, and 115 can be executed concurrently or at different times. There can be more or fewer than 5 CSAs in a particular embodiment.

In an embodiment, annotations stored in local data storage 114 are stored so that they are linked to the original data, which they describe. In an embodiment, for example, annotations are linked to the data elements they describe using the original data ID of the data elements. In an embodiment, each annotation corresponds to an original data ID of a particular data element or component in the local data storage 114. In an embodiment, archived data and corresponding annotations in the local data storage 114 are accessible through the representation of a virtual three-dimensional object visualization designed to interact with a human user interface 101 and 119.

In an embodiment, each annotation is stored as a parallel layer of information or a relational database pairing to the original data ID pair within the data stored in the local data storage 114. The original data ID gets propagated through the new annotations linked to the particular ID. In an embodiment, the original source of the data is paired to the original data in the form of an annotation.

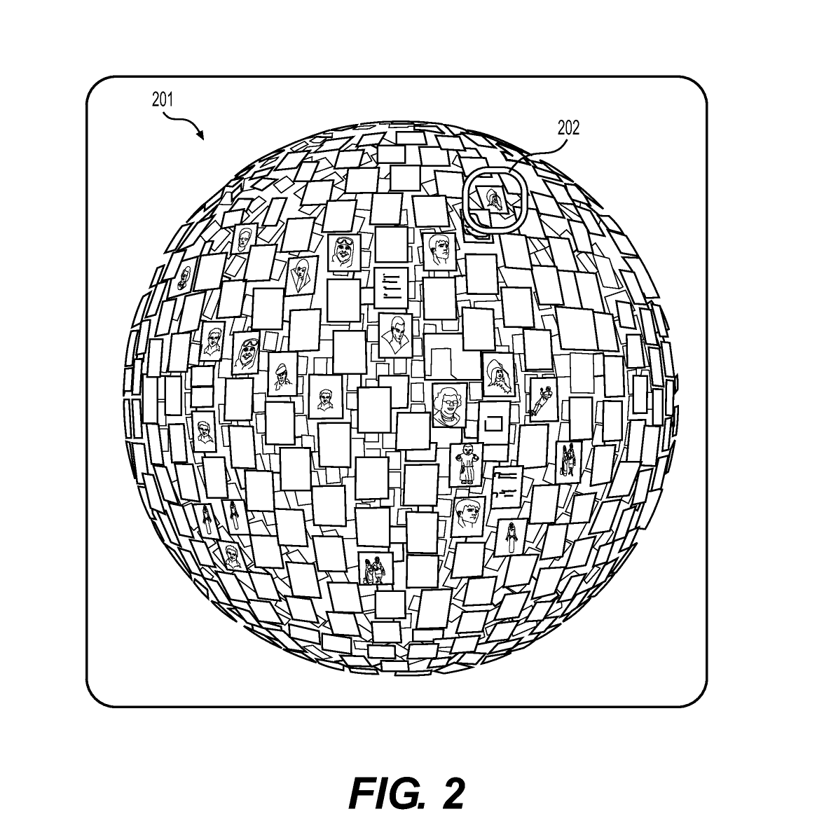

FIG. 2 illustrates an exemplary virtual three-dimensional object 201 that shows a plurality of subdivisions, for example, subdivision 202, according to an embodiment of the present invention. Virtual three-dimensional object 201 can be any three-dimensional object that can contain subdivisions and extrusion as described herein, including spheres, cubes, cylinders, cones, prisms, polyhedrons, pyramids and any other three-dimensional object. As shown in FIG. 2, in an embodiment, virtual three-dimensional object 201 is a sphere, also referred to herein a haptic sphere. The data represented in haptic sphere 201 is stored in local data storage 114, and comprises a plurality of images.

In an embodiment, to represent the individual data elements of the local data storage 114, haptic sphere 201 is segmented into subdivisions, one subdivision per data component or element stored in the local data storage 114. In the embodiment illustrated in FIG. 2, for example, each subdivision includes an image icon representative of the data underlying the subdivision. In an embodiment, as shown in FIG. 2, haptic sphere 201 has transparency such that a user can see to the other side of haptic sphere 201, as if looking through haptic sphere 201.

In an embodiment, each subdivision has associated with it an image ID. The image ID is an exemplary original data ID. Each image record contains, in addition to the image ID, a record of all the annotations corresponding to that image. For example, subdivision 202 has an image that has, for purposes of explanation, been assigned image ID 1. Image ID 1 can further have associated with it value for various categories of annotations, such a nouns, verbs, dates, and source, corresponding to particular annotations.

As described above, annotations are linked to the data elements they annotate in local data storage 114. In an embodiment, linking is provided using the original data ID. In such embodiment, each annotation is associated with zero, one or more original data IDs. In this manner, annotations are linked to data elements by original data ID. In another embodiment, each annotation is assigned a unique annotation ID. For example, the unique annotation ID can be the next value in a one up counter. In such embodiment, each data element is associated with zero, one or more annotations IDs. In this manner, data elements are linked to annotations through the annotations IDs. In an embodiment, both original data IDs and annotations IDs are used. Linking in such embodiment can be either one of or both of the methods described in this paragraph.

When data responsive to a query is presented to an analyst in haptic sphere 201, the subdivisions corresponding to the responsive data are activated. In an embodiment, activation of a subdivision can be by color, extrusion, extrusion length, extrusion width, extrusion sharpness, animation such as flashing, vibrations, or other animation, or any other way to distinguish a subdivision in data sphere 201. In an embodiment, the subdivisions are activated by representing them as extrusions, with the extrusion height corresponding to how well the underlying data matches (i.e., is relevant to) the query.

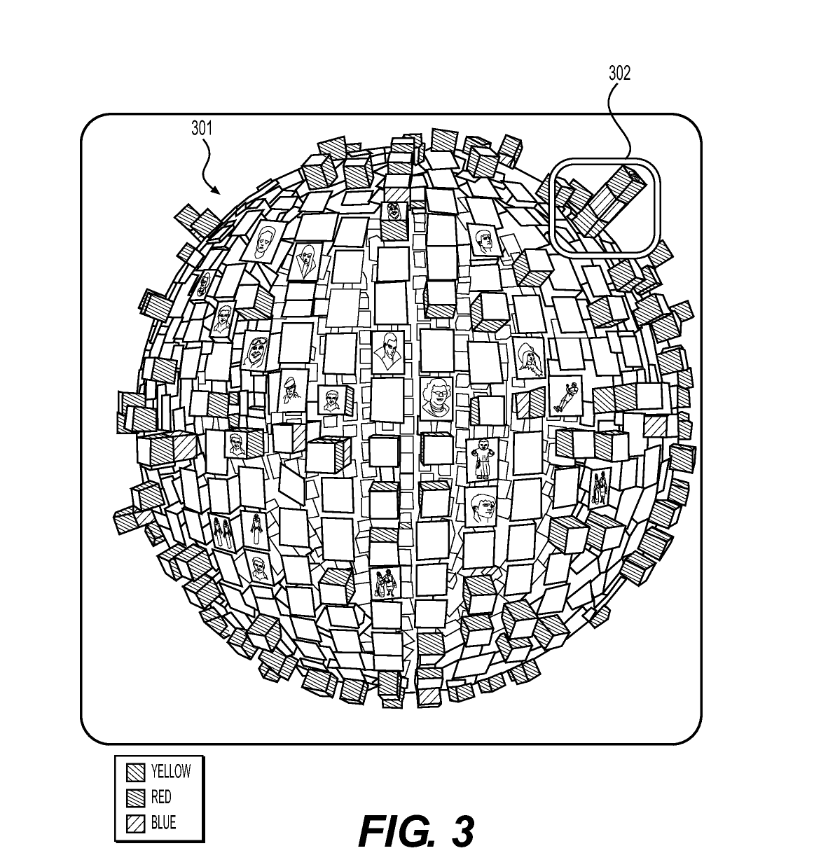

FIG. 3 illustrates an exemplary virtual three-dimensional object, in this example a haptic sphere 301, that represents data in a data repository. Haptic sphere 301 shows extrusions that assist a user in understanding the data according to an embodiment of the present invention. In haptic sphere 301, subdivisions, such as subdivision 302, are activated in response to a user query to illustrate not only data that is responsive to the query, but how relevant that data underlying the subdivision is to the user query. As shown in FIG. 3, subdivision 302 is extruded to show how closely subdivision 302 matched a query, for example, illustrating which annotations of the query match annotations in the data underlying subdivision 302. The extrusions assist a user in understanding the relevance of the data to the query. In an embodiment, the user can manipulate haptic sphere object 301 to analyze the underlying data. Such manipulation can include rotation, zooming in and out of the sphere, and tactile interaction using a haptic interface, such as a haptic glove.

In an embodiment, data stored in the local data storage 114 is queried to further narrow and refine results of data searches. In an embodiment, to query the data in the local data storage 114, the analyst enters keywords or strings using a human user interface 101. In an embodiment, queries comprise typed information that may be found in the pre-existing annotations of the original data or annotation generated by the CSAs or entered by an analyst for particular data elements. Thus, query inputs can include information the user is searching for without the user having to know whether the query terms used are present in the local data storage 114.

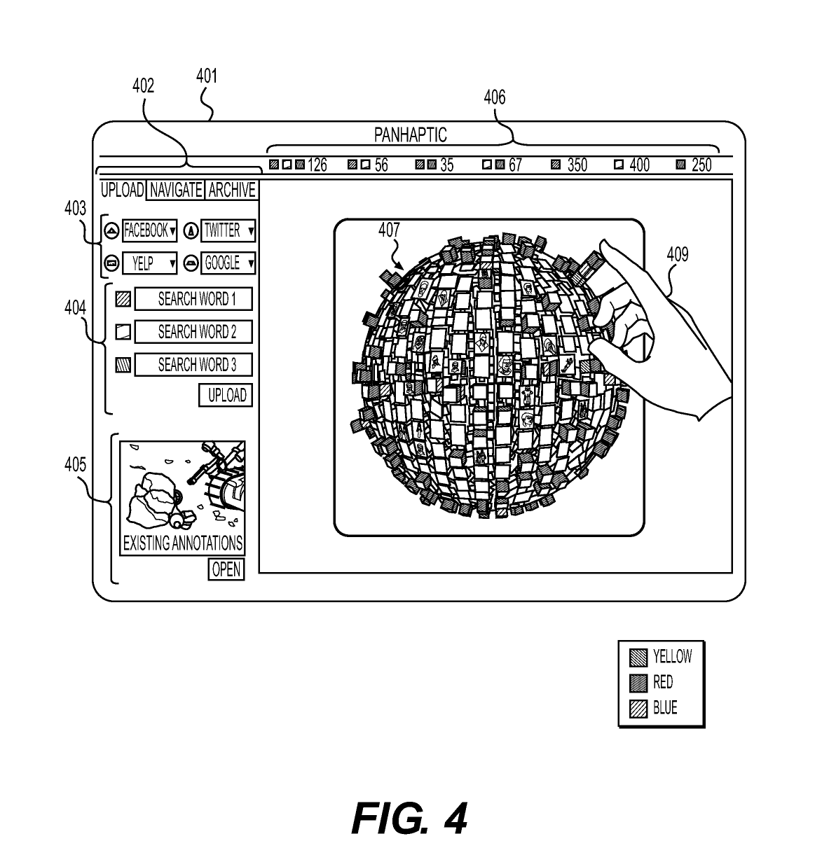

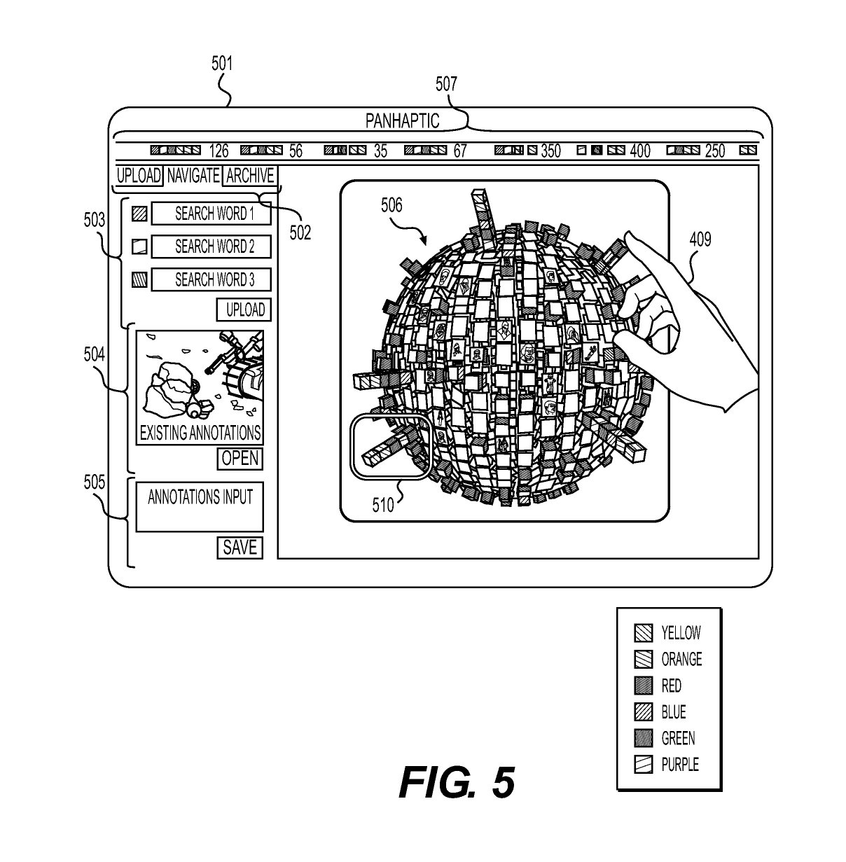

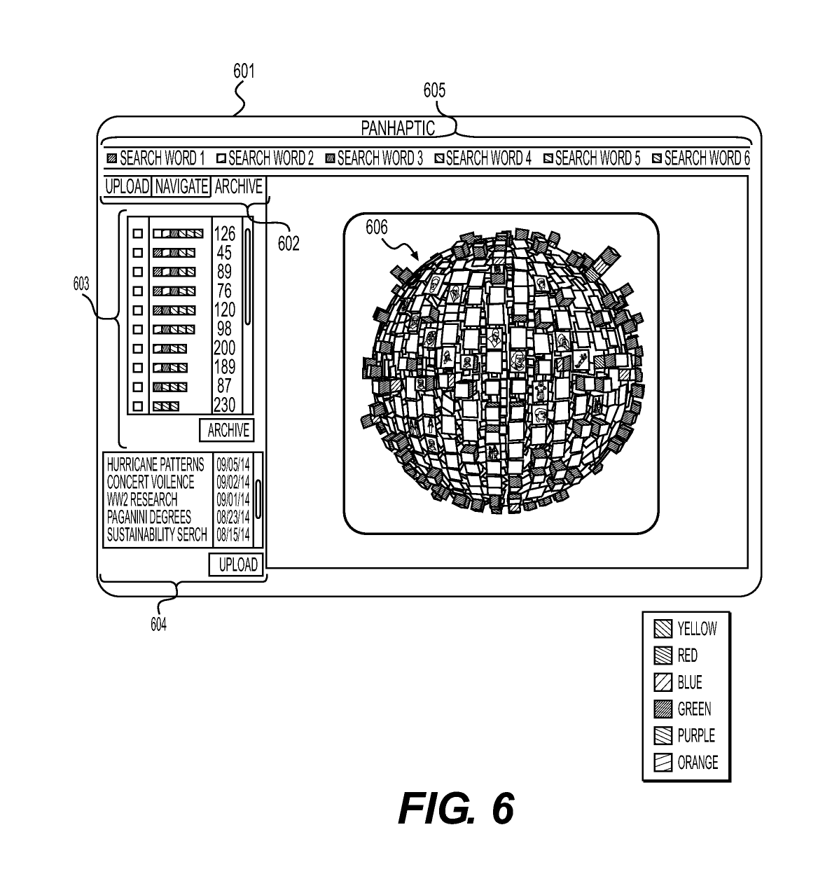

FIGS. 4-6 illustrate an exemplary human user interface 101 according to an embodiment. In an embodiment, human user interface 101 comprises an upload interface 401, a navigation interface 501, and an archive interface 601. An analyst can move between the interfaces by selecting the appropriate button in panel 402 of FIG. 4, panel 502 of FIG. 5, and panel 602 of FIG. 6.

FIG. 4 illustrates an exemplary upload interface 401 for entering keywords and/or strings to retrieve and structure external data from outside data sources 110-113 to interact with a virtual three-dimensional object representation of the retrieved data according to an embodiment. If a user is not already in upload interface 401, to navigate to upload interface 401, in an embodiment, the user selects UPLOAD from panel 502 of FIG. 5 or panel 602 of FIG. 6. Using upload interface 401, an analyst can modify, add, or delete outside data sources as well as enter keywords and strings that inform the custom search algorithms 106-109 to retrieve from outside data sources 110-113. In an embodiment, the analyst selects one or more outside data sources using outside data source selection box 403. For example, as shown in FIG. 4, the outside data sources are Facebook, Twitter, Yelp, and Google.

Using a query box 404, the analyst can enter one or more search terms, such as keywords or strings, with which to search outside data sources 110-113. Data responsive to the query keywords and/or strings is stored in local data storage 114, along with pre-existing annotations, or annotations generated by a CSA or entered by an analyst. In an embodiment, data stored in local data storage 114 is represented in a subdivided virtual three-dimensional object 407. In the example of FIG. 4, virtual three-dimensional object 407 is a haptic sphere.

To form a query in an embodiment, three or more keywords and/or strings are typed into the input boxes in query box 404, which inform the CSAs 106-109 of what data to retrieve from outside data sources 110-113. Thus, in an embodiment, the analyst selects the keywords and/or strings having the annotations they desire to search for in the query. In an embodiment, data responsive to the query, for example, data matching the annotations, is retrieved from outside data sources 110-113, stored in the local data storage 114, and displayed as a subdivision in the subdivided virtual three-dimensional object 407. In an embodiment, upload interface 401 allows the analyst to select an outside data source to query in outside data source selection box 403, and to create and submit queries comprising keywords and/or strings using query box 404. In an embodiment, each subdivision in the virtual three-dimensional object 407 represents one data component, for example one image, extracted from the outside data sources 110-113 and saved in the local data storage 114.

In an embodiment, subdivisions are represented as extruded when their underlying data includes keywords or strings entered by the analyst. Thus, extruded subdivisions of the virtual three-dimensional object 407 represent data containing keywords or strings entered by the analyst. In an embodiment, the height of the extrusion is proportional to the number of keywords or strings found in that particular data component. In an embodiment, the analyst can select any subdivision of the virtual three-dimensional object 407 to display the original data, that is, the data retrieved form the outside data source, in a data display portion 405 of upload interface 401. In an embodiment, the analyst is also shown the number of combinations of keywords or strings represented in the three-dimensional object 407, and therefore in the data, in a results panel 406. In the example upload interface 401, 126 data elements contain all 3 search words/strings, 56 data elements contain search words/strings 1 and 2, 35 data elements contain search words/strings 1 and 3, 67 data elements contain search words/strings 2 and 3, 350 data elements contain only the first search word/string, 400 data elements contain only the second search word/string, and 250 data elements contain only the third search word/string.

FIG. 5 illustrates an exemplary navigation interface 501 to allow an analyst to enter keywords or strings to retrieve, refine, and structure, data from local data storage 114 and interact with a virtual three-dimensional object representation 506 of the refined data according to an embodiment of the present invention. If a user is not already in navigation interface 501, to navigate to navigation interface 501, in an embodiment, the user selects NAVIGATE from panel 402 of FIG. 4 or panel 602 of FIG. 6. Using navigation interface 501, an analyst can further refine data analysis of data stored in local data storage 114. As layers of annotations are added, for example using annotation manual input 505 in navigation interface 501, users can develop increasingly narrow queries for very specific data mining.

To form a query in an embodiment, three or more keywords or strings are typed into a query box 503. The query informs the custom search algorithms 115 of what data to extract from the local data storage 114. Thus, in an embodiment, the analyst selects the keywords or strings having additional annotations they desire to search for in the query. In an embodiment, the annotation query is extracted from the local data storage 114, and displayed as additional extrusions, for example, additional extrusion 510, in the subdivided virtual three-dimensional object 506. In addition to new extrusions, a new query can cause current extrusions to change in size and shape in response to the new query. The highest extrusions contain all keywords or strings entered during the upload process 401 as well as the navigation process 501. In an embodiment, the analyst is also shown the number of combinations of keywords or strings represented in virtual three-dimensional object 506 in a horizontally scrolled results panel 507.

In an embodiment, the analyst can select any subdivision of the virtual three-dimensional object 506 to display the original data, that is, the data retrieved from the outside data source, in a data display box 504 of navigation interface 501. The analyst may also manually add annotation in the annotation input box 505 to develop increasingly narrow queries for very specific data mining.

FIG. 6 illustrates an exemplary archive interface 601 to allow an analyst to archive refined and structured data, combine archived data, and cross examine data using the virtual three-dimensional object representation of the archived data according to an embodiment of the present invention. If a user is not already in archive interface 601, to navigate to archive interface 601, in an embodiment, the user selects ARCHIVE from panel 402 of FIG. 4 or panel 502 of FIG. 5. Using archive interface 601, an analyst can save all or portions of the queried data into visualization storage 120. In an embodiment, the analyst may archive data according to relevance of the keywords or strings entered. In an embodiment, a list of query results is displayed with capacity to select combinations of queried results in an archive box 603. For example, the analyst may select query results that have all six keywords or strings that were queried for during the upload 401 and navigation 501 processes by selecting an appropriate check box in archive box 603. In an embodiment, the analyst can store a name or label associated when the analyst archives a query to visualization storage 120. These archived data sets are “structured” data sets. These archives of data and annotations can be used in the same manner as the original retrieved data, and serve as a basis for more specific queries over a smaller data set. An archive retrieval box 604 allows the analyst to retrieve archived queries. In an embodiment, available archives are presented to the analyst using saved names/labels and/or archival dates. The analyst may also load the saved data into the local data storage 114 and conduct additional queries within the navigation user interface 501. In an embodiment, archive interface 601 includes a query term panel 605 that presents all query terms used in a particular query being archived or retrieved. In an embodiment, a virtual three-dimensional object 606 provides a graphical representation of the query being archived or the query being retrieved.

In an embodiment, using archive interface 601 extruded subdivisions may be archived as having a specific query in common. This allows creation of an additional annotation for each component. When multiple groups are created, these can be stored in local data storage 114 and queried on a larger scale, that is, queried for components with queries in common. This allows for very specific data navigation.

Each query includes keywords or strings of interest to the analyst for the particular query. For example, an exemplary input for a query can include a combination of annotations such as time, geospatial location, original data source, verbs such as holding, dropping, and picking up, and nouns such as bag, weapon, or child. For the example of violence in Bicentennial Park, which is located at longitude 80.2 degrees W and latitude 25.7 degrees N, the query may include the annotations “gun”, “crowd”, “fight” and “Longitude 80.2 degrees, Latitude 25.7 degrees”. Combinations of queries can be used to obtain greater specificity for navigation.

In an embodiment, the analyst can provide one or more output annotations when saving the query. An output annotation is an annotation that can reference a specific context, scenario or case study as a result of being included in the query. The output annotations are additional annotations the analyst can use as query items in future searches. The subsequent annotations are stored in the user visualization storage 120 for future analysis. For example, for the input annotations, holding, dropping, and picking up, in the context of potential suicide bombers, the output annotation can be “bomber”.

Using annotation-data pairings in this manner, multiple analysts can query archives of annotated data stored in local data storage 114 as well as new annotations created by naming and saving groups of queried results during the archiving process, for example, using archive interface 601 in FIG. 6. These new search results can be archived separately from prior searches. Because they also store results as annotations linked to the original data, these new results can form the basis of a new, narrower search through the original data.

In an embodiment, default parameters can be set up to generate the extrusions. For example, in an embodiment, the default parameters are stored in an extrusion configuration file. The extrusion parameters can include any parameter to generate the extrusion, including for example, color, length, shape, sharpness, etc. In an embodiment, the analyst can modify, add, and delete the default extrusion parameters by, for example, modifying the configuration file where the parameters are stored. The user-specified or default parameters are applied to the particular subdivisions based on values returned in response to the queries, and the haptic sphere is displayed with extrusions conforming to the parameters specified by the analyst. For example, extrusions corresponding to data that better fits a query (i.e., is more relevant to a query) may be longer, sharper, have a certain color, etc. or combinations of these parameters.

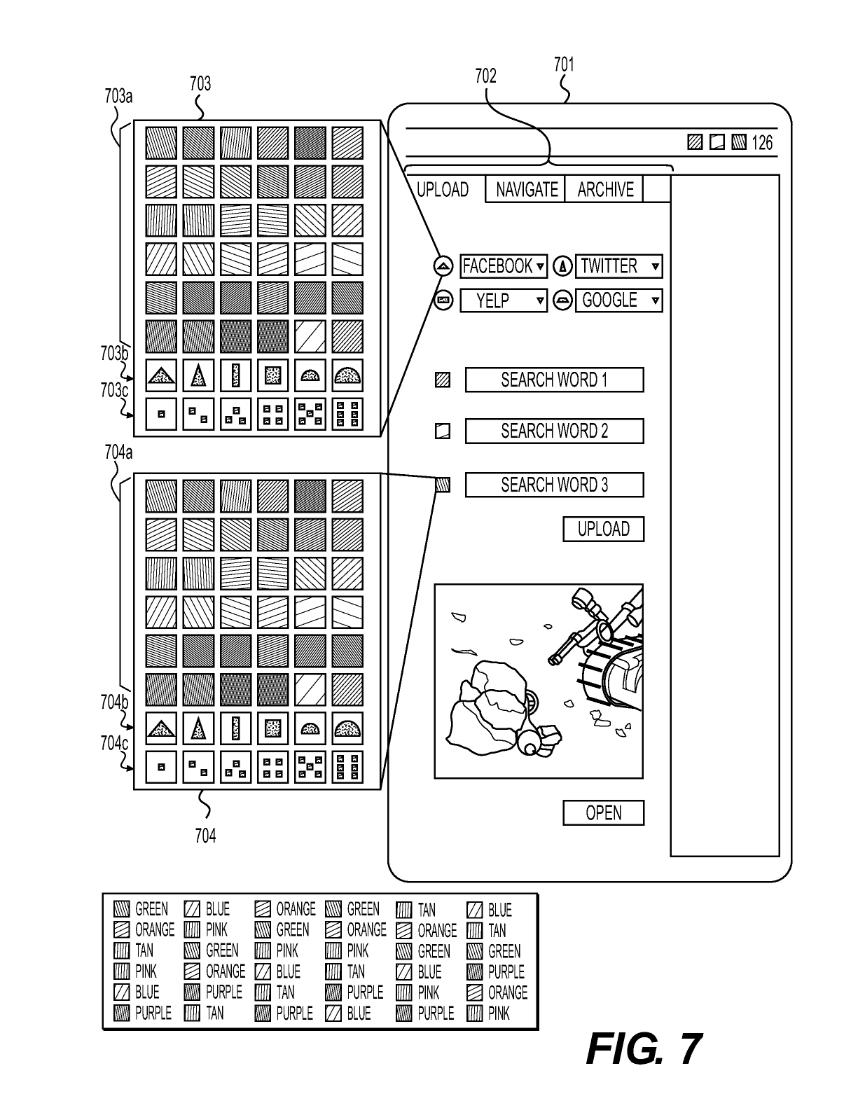

FIG. 7 illustrates an extrusion parameter configuration interface 701 according to an embodiment. Extrusion parameter configuration interface 701 allows a user to modify the appearance and/or “feel” of extrusions in the three-dimensional object. In an embodiment, extrusion parameters are stored in an extrusion parameter configuration file. Any modifications made using extrusion parameter configuration interface 701 update corresponding parameter values stored in the extrusion parameter configuration file.

In an embodiment, parameter configuration is done from the upload interface when selecting outside data sources. An extrusion parameter configuration box 703 allows customization of the appearance and/or “feel” of extrusions corresponding to a particular outside data source. In an embodiment, data source extrusion parameters affect the top of an extrusion. A search term (e.g., keyword and/or string) extrusion parameter configuration box 704 allows customization of the appearance of extrusion segments corresponding to a particular search term. Multiple colors can be used in extrusions. In an embodiment, search term extrusion parameter colors affect the body of an extrusion and search term extrusion parameters shapes/tactile indicators affect the top of an extrusion. For example, colors may be used to identify query search terms contained in the underlying subdivision to which the extrusion applies as well as the original source from which the data was retrieved. In addition, the tops of extrusions can be modified to represent, for example, a data source or an important data source reflected in the data underlying the extrusion, or that an important search term is reflected in the data underlying the extrusion.

For example, as shown in FIG. 7, in an embodiment four outside data sources are available: Facebook, Yelp, Twitter, and Google. A color palette 703a allows selection of a different color for each data source. A shape palette 703b allows selection of a different shape for each data source. A tactile indicator palette 703c allows selection of a different tactile indicator for each data source. A tactile indicator provides information by raised surface from a flat surface, such as Braille. For example, as shown in FIG. 7, a tactile indicator has a raised number of dots on a square surface. The number of dots can be used to differentiate data sources.

A different color and a different extrusion top shape can represent each data source. For example, as shown in FIG. 7, data retrieved from outside data source Twitter is represented under a sharp triangular extrusion top shape and Yelp is represented as rectangular extrusion top shape. Any number of external data sources can be used in a particular implementation. In an embodiment, different outside data sources can be represented by extrusions having different colors and shapes. Top shapes or tactile indicators might not be used at all if images or videos are used instead, for example, such as in FIG. 2. In the embodiment of FIG. 7, six color, shape, and tactile indicator options are provided. In an embodiment, any number of colors, colors, shapes and tactile indicator options can be provided in extrusion configuration parameter box 703.

In an embodiment, matching search terms (e.g., keywords and/or strings) are represented by different colors in an extrusion. A color palette 704a allows selection of a different color for each search term. A shape palette 704b allows selection of a different shape for each search term. A tactile indicator palette 704c allows selection of a different tactile indicator for each search term. A tactile indicator provides information by raised surface from a flat surface, such as Braille. For example, as shown in FIG. 7, a tactile indicator has a raised number of dots on a square surface. The number of dots can be used to differentiate search terms. Important matching search terms can be represented by shapes or tactile indicators.

For example, as shown in FIG. 7, in an embodiment up to three search terms can be chosen to apply against annotations of the data elements in a data set being interrogated. Each search can be represented by a different color. In some cases, such as the scenario described in the following paragraph, a different extrusion top shape can represent a search term especially those relating to time and location. For example, in FIG. 7, “Search Word 3” is represented by the color green. Therefore, any extrusions corresponding to a data element having the annotation “Search Word 3” would have a green segment in the extrusion. Any number of search terms can be used in a particular implementation.

For example, in a scenario looking for social media data related to violence in a park, CSAs can retrieve data components from outside data sources relevant to the park and store the data in local data storage 114 along with any pre-existing annotations in the outside data sources or annotations added by the CSAs or analyst. A virtual three-dimensional object representing the data stored in local data storage 114 is generated and divided into the number of social media data components retrieved from the outside data sources and stored in local data storage 114. A query is configured to look for nouns such as knife, gun, and sharp-object, as well as verbs such as punch, grab, drop, and throw. If any of these nouns and verb appears in the annotations in the social media components, the length of the extrusion corresponding to each comment with the annotations will increase depending on the number of relevant annotations within that comment. Additionally, if the query includes a specific time of interest, the sharpness of the extrusion may vary, similarly if a specific location is of interest then color may be implemented. Vibrations, sounds, and smells are additional layers that can be implemented for additional multisensory memory recall. Parameters can be combined as well. For example, an analyst can configure an extrusion's length and sharpness to increase when a particular annotation is matched.

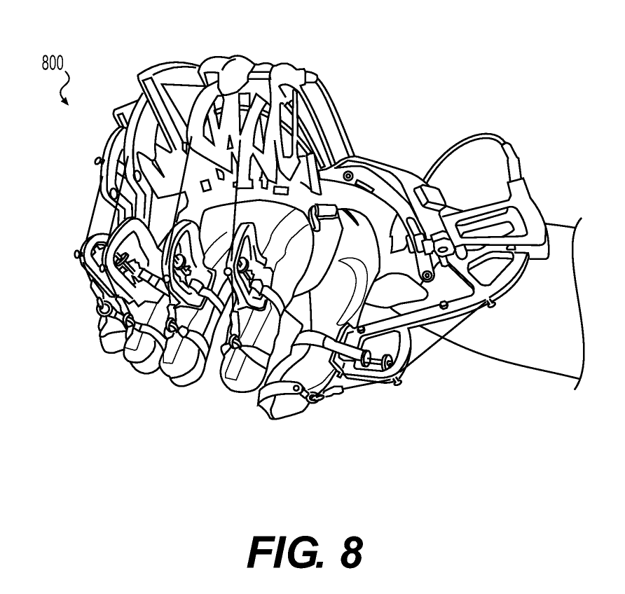

In an embodiment, the analyst can select a particular extrusion or multiple extrusions to access the original source data. Selection can be made with any device for selection, for example a mouse, a trackball, touchpad, etc. As shown in FIGS. 4 and 5 selection is performed using a haptic glove (described with respect to FIG. 8) where a user/analyst selects an extrusion by tapping on the haptic sphere in order to view the original source data 405 and 504 as well as any additional annotations paired with that original data ID. In FIG. 5, the user may also enter additional attributes in additional annotations box 507.

Using the extrusions, an analyst is far more likely to be able to identify data of interest from big data sets than is possible with conventional techniques. The ability for the analyst to be able to find particular data of interest in large data sets is made even easier by allowing the analyst to interact with a haptic sphere, such as haptic sphere 201, 301, 407, 506, or 606 using the sense of touch. Such tactile interaction can be achieved using, for example, a haptic glove such as the one shown in FIG. 8.

In an embodiment, the virtual three-dimensional object, such as the haptic sphere 201, 301, 407, 506, or 606, is controlled by a controller 117. Controller 117 can be any controller or combination of controllers that can be used to manipulate the virtual three dimensional object, including, for example, a conventional mouse and keyboard, a gesture controller, a haptic controller, or any other controller that can be used to interact with the virtual three-dimensional object to orient it and select extrusions, including future controllers such as voice-activated controllers and electroencephalography-based controllers. For example, an embodiment uses a conventional mouse and keyboard to interact with the three dimensional object. Such an embodiment may be useful to provide a smooth transition from conventional analysis to bidirectional seamless feedback using, for example, the combination of haptic glove and electroencephalography technology. Double clicking or hovering over an extrusion provides the user with access to the source data underlying the extrusion clicked on by the user. A gesture controller allows a user to interact with the virtual three-dimensional object by intuitively moving their hands to rotate and activate the virtual three-dimensional object and its components. A haptic controller allows the analyst to feel the virtual three-dimensional object as it changes over time and as queries are modified.

In an embodiment, controller 117 is a haptic controller. Where controller 117 is a haptic controller, the analyst feels the virtual three-dimensional object extrusions change in response to different queries. The analyst can use the haptic controller to “push back” on virtual components such as extrusions. For example, pushing back on extrusion 302 provides the analyst access a display of the original data underlying the extrusion upon which the user pushed. Pushing back on an extrusion also provides the user additional connections to other components within the repository and queries. The user can select extrusions in other ways as well, for example, by touching the extrusion with the haptic glove or selecting it with a mouse, among others. The user is also able to contribute additional annotations and structure using navigation interface 501, voice activation, and eventually electroencephalography.

FIG. 8 illustrates an exemplary haptic glove 800 according to an embodiment. A haptic glove can detect and translate hand movements into a virtual representation of those movements. Using the haptic glove, the user can then manipulate and feel the virtual environment. An exemplary haptic glove are the CyberGrasp™ and CyberForce™ haptic-feedback interfaces available from CyberGlove Systems, LLC in San Jose, Calif. Additional details of these interfaces can be found in the CyberGrasp™ System v2.0 User Guide, the CyberGrasp™ Data Sheet, and the CyberForce™ Data Sheet, each of which is hereby incorporated by reference herein in its entirety.

In the context of embodiments of the present invention, haptic glove 800 allows the user to manipulate the virtual three-dimensional object and extrusions representing the data in local data storage 114. For example, the user can rotate the virtual three-dimensional object, and can select data by pressing on extrusions. In addition, the user can feel the height and sharpness of extrusions using the haptic glove. In this manner, users will be able to search through large data sets by feel, not solely visually.

Tactile interaction with the data allows an analyst to process the data much more efficiently than simply using sight alone. This is because length, width, color and sharpness of an extrusion allow multiple layers of queries to be visualized and felt at once with the use of a haptic glove 800 in addition to vision.

The visualized data results produced by visualization module 116 such as haptic spheres 201, 301, 407, 506, and 606, can be presented in any human user interface 119 that can display a virtual three-dimensional graphical representation of data to an analyst.

In an embodiment, an analyst can also export the results of a particular query through an automated computer 118. An automated computer is a program written to automatically perform certain tasks. For example, an initial automated computer API 102 may be programmed to automatically input specific queries at different times of the day or according to any other programmed parameter. Another automated computer API 118 may be programmed to export into spreadsheets as a result of specific query combinations. In an embodiment, data can be exported in any format such as a spreadsheet, map, two-dimensional diagram, and three-dimensional diagrams. Diagrams are, for example, visual representations of the relationships made between the individual pieces of data selected from the local data storage 114 and the annotation linked to the original data ID of the particular data in question in the context of a specific scenario.

Through the query process, new information is reflected in virtual three-dimensional object 201. This is possible because all the annotations are linked to the local data storage 114 and therefore to each individual component reflected in the virtual object 201.

In an embodiment, haptic glove 800 may be represented on screen as a virtual hand, for example, virtual hand 409 in FIGS. 4 and 5. In operation, the analyst will see the virtual hand 409 and control virtual hand 409 using a haptic glove. In an embodiment, when virtual hand 409 gets in proximity to data sphere 407 and 506, it activates its ability to interact with data sphere 407 and 506. The data is transformed into touch by programming the glove to react to the surface and extrusions of virtual object 407 and 506. The analyst feels differences in elevation and width of the extrusions as the query process activates these. The user feels information changing over time and over a series of queries and tactically detects information such as abnormalities and inconsistencies in the data.

The virtual data object may also be programmed to react to a virtual hand, for example, pressing on the extrusions in order to bring up the original source of the data, selecting different subdivisions in a virtual data object, or selecting a different object on the screen. In embodiments, manual and/or voice activated commands expand the interaction between the virtual hand and virtual subdivided object. Outside of proximity to the virtual object, the virtual hand can interact with other parts of the user interface, such as the control buttons.

In an embodiment, input from automated computer API (application programming interface) can retrieve data corresponding to a real-time monitoring system such as, for example, data from cameras, gas sensors, radioactivity sensors, and/or other sensors operating simultaneously, which outside data sources 110-113 make available almost immediately for processing as described above. In another embodiment, custom search algorithms 106-109 perform its structuring operation directly on the data or feeds from the cameras or sensors as it is retrieved to the local data storage 114. Regardless of how the data is processed in such a real-time system, haptic glove 800 allows fingers and hands to feel fluctuating information within large real-time data as it is stored locally 114 in real time. For example, in an embodiment, components on the surface of the virtual three-dimensional object are linked to individual video camera feeds (and/or other sensors), and automatically configured to filter specific information in real time. The analyst can feel numerous objects at once and monitor behavior of interest in real time.

For example, the analyst may feel 10,000 sensors or monitors, such as cameras, radioactivity or gas level sensors, or a combination of these and other sensors or monitors at the same time, and monitor all activity in real time. Whenever an alarming annotation is detected by one or more monitors and/or sensors, for example, a weapon, or radioactivity or gas level, an extrusion corresponding to the affected sensor or sensors will have a height significantly larger than the rest and the analyst can press on that extrusion to immediately bring up the original feeds in for example display box 405 or display box 504 while continuing to feel the activity on the virtual object. Moreover, the extrusions corresponding to the affected sensor can have different characteristics depending on the severity of the condition being detected by the sensor.

Virtual three-dimensional object 201 is designed to change as concepts of interest within local data storage 114 change, and as user visualization storages 120 and live feeds change. Haptic glove 800 is programmed to transfer tactile feedback to the hand anytime valuable information is detected. The user feels high-level data while utilizing vision to see the original source of valuable data in display box 405 or 504 through the different options within human user interface 119.

In an embodiment, no local data storage is used when outside data sources are consistent. Instead queries are made to outside data sources 110-113. Data retrieved in response to the queries is presented in the virtual three-dimensional object.

Although embodiments have been described above with respect to structuring, storing and visualizing the data, any mechanism can be used to create and store annotations having the characteristics and functionality described above.

In an embodiment, rather than retrieve data as well as annotations in response to a query to outside data sources 110-113, only annotations are returned and stored in local data storage 114. This reduces significantly the amount of data that need to be stored in local data storage 114, as well as the bandwidth require to initially store the data. However, when the user selects a particular extrusion, the underlying data must be obtained from outside data sources 110-113 using the linking information in the stored annotations such as original data IDs that link the annotations back to the data in outside data sources 110-113 with which they are associated.

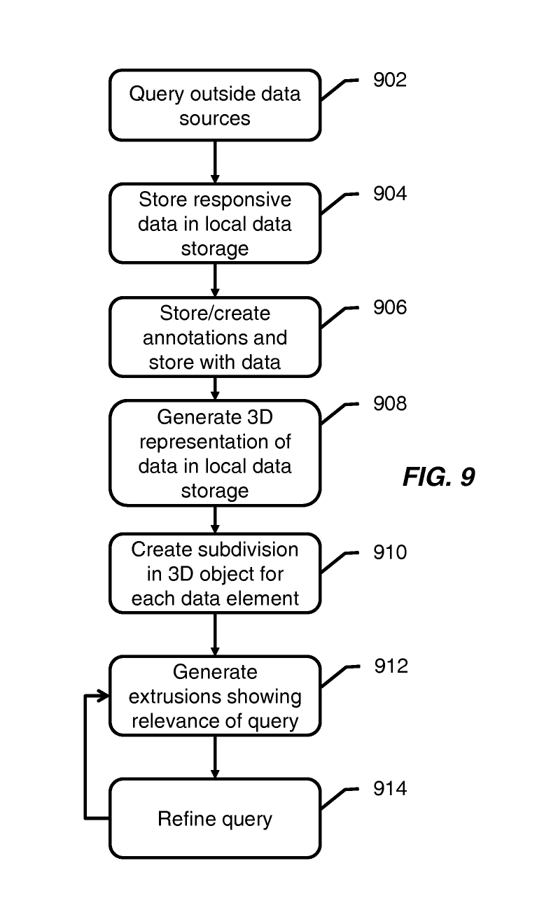

FIG. 9 is a flow chart for a method for mining data using haptic feedback according to an embodiment of the present invention. In step 902, one or more outside data sources are queried, for example using a human user interface 101. In step 904, data responsive to the query is stored in a local data storage, for example using retrieval modules 104 and 105. In step 906, annotations are stored and/or created and stored in the local data storage in association with the data they add value to or describe. In step 908, a three-dimensional representation is created of the data stored in the local data storage, for example, creating a three-dimensional representation using visualization module 116. In step 910, a subdivision is created in the three-dimensional representation for each data element stored in the local data storage, using for example, visualization module 116. In step 912, extrusions are generated for each subdivision that shows the relevance of the data underlying the subdivision to the query, for example, using visualization module 116. In step 914, the query is refined if desired, and processing continues in step 912 by updating, adding, and or deleting extrusions in response to the updated query, using for example, module 104. Steps 912 and 914 can be repeated as desired.

Human user interfaces 101 and 119, CSAs 106-109 and 115, data retrieval and refinement 104 and 105, visualization module 116, automated computer APIs 102 and 118, and software for controller 117 can be implemented on one or more computers, for example, personal computers. Such computers, which, in general, comprise one or more processors, memories, I/O ports to connect to devices and networks, internal and/or external memory, input/output devices such as mouse, keyboard, one or more display screens, for example, to display human user interfaces 101 and 119, and buses to connect one or more elements of the computer are well-known to those having skill in the art. Such computers can be networked with one or more other such computers and/or storage devices over an Internet, intranet, wide area network, local area network or other network using any number of network protocols. Programming such computers to perform the operations described herein would be well-known to those having ordinary skill in the art.

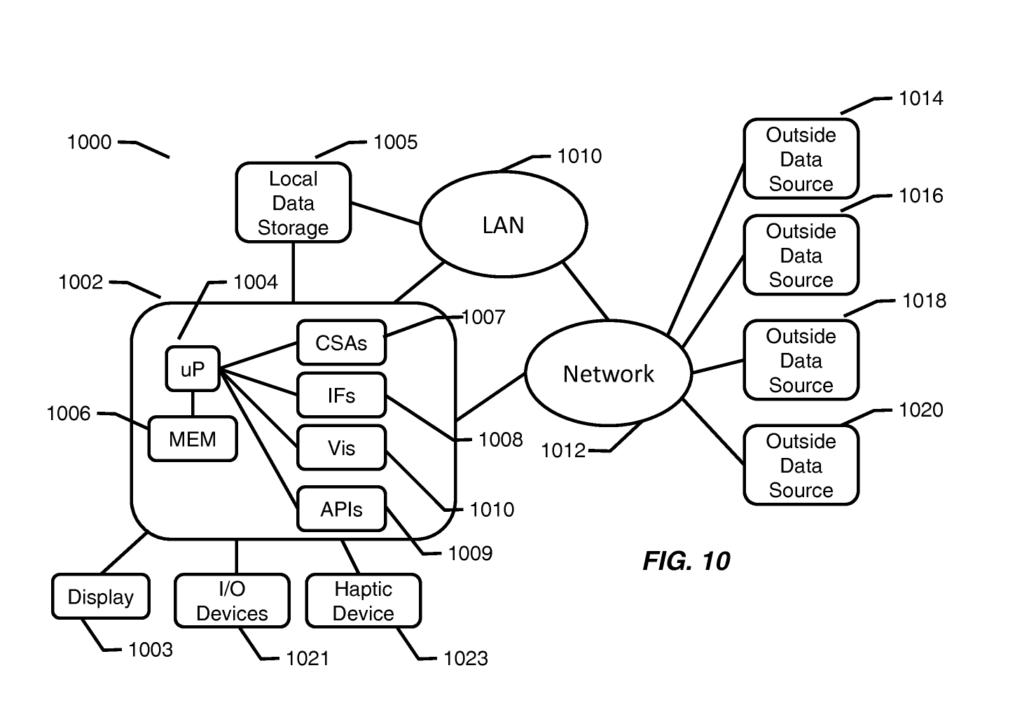

FIG. 10 is a schematic diagram of an exemplary environment 1000 for mining data using haptic feedback according to embodiment of the present invention. A computer 1002 includes at least one microprocessor 1004 to execute applications. Computer 1002 can be any computer that can execute processes as described herein such a personal computer, and can be multiple computers. Microprocessor 1004 has access to a memory 1006 that is can access or use as required in executing applications. In an embodiment, microprocessor 1004 executes one or more CSAs 1007 such as CSAs 106-109 and 115. Microprocessor 1004 also executes one or more interfaces 1008 such as human user interfaces 101 and 119 on a display 1003. Microprocessor also executes a visualization module 1010, such as visualization module 116 to provide a display of a virtual three dimensional object representation of data stored in a local data storage 1005, such as local data storage 114 on display 1003. Microprocessor 1004 also executes one or more APIs such as API 102 and 118.

A user can provide search terms or manipulate the three-dimensional object using I/O devices 1021. Exemplary I/O devices include a mouse, a keyboard, or a voice recognition device. A haptic device 1023, such as haptic glove 800 provide haptic control and feedback of the three-dimensional object as described herein. Searches are performed on one or more outside data sources, 1014, 1016, 1018, and 1020. Access to outside data sources, 1014, 1016, 1018, and 1020 can be through a network 1012. Network 1012 can be any network such as the Internet, an intranet, a local area network, a wide area network, etc. Computer 1002 can be coupled to local data storage 1005 directly or through a local area network 1010. In an embodiment, local data storage is in the cloud and accessible through network 1012. Computer 1002 can be coupled to network 1012 directly or through local area network 1010.

Following are exemplary use cases for embodiments of the present invention:

### Use Case 1: Structuring Large Data Repositories

An embodiment of the present invention provides a method for structuring large data repositories by manually overlaying and archiving annotations at a range of scales, anywhere from one individual component to macro groupings of information containing multiple types of media formats.

Individuals or companies storing large data repositories ultimately need to structure the data they hold to extract its qualitative value. Currently, analysts charged with the duty of structuring data resort to manually sourcing through the data or work with graphic artists and programmers to visually represent the mined data within the repository. Most data visualization software available to analysts is limited to standard graphs and charts. Such rudimentary techniques invariably lead to inaccuracies due to the analyst's inability to personally customize the visualization of the sought-for information, as well as limitations of software's, artists′, and programmer's understanding of the information's qualitative value.

A panhaptic interface of embodiments allows an analyst to structure data repositories using trained algorithms to annotate components within the repository. The ability of the analyst to structure and visualize large amounts of data leads to the reduction of inaccuracies in the data output, the number of personnel required to accomplish the task, and, consequently, the time and cost involved in structuring the data. Further, the use of a haptic glove and a virtual object enables an analyst to feel patterns of relevant information and sense the degrees of relevancy based on the various levels of extrusions. This provides the analyst with greater capacity to understand and navigate the data.

Depending on the scenario, a different algorithm may be used to structure the data, for example, key value pairing to search for specific terms and combinations of terms. Image and video recognition may require the analyst use a computer vision algorithm to interpret the image. For text and number recognition, the analyst uses a natural language processing algorithm. For frequency recognition, the analyst uses a signal-processing algorithm.

### Use Case 2: Structure Multiple Data Sources in Parallel

Another embodiment of the present invention provides a tool for navigating multiple data sources by retrieving external data from a variety of data repositories into a single local data storage. An analyst may then cross-analyze the different sources of data. The analyst may also structure and archive data from multiple sources to produce hybrid query results.

A major challenge individuals and companies face is the ability to analyze multiple data sources at once. In most cases, valuable information narratives must be stitched together from multiple data sources. Analysts using conventional visualization programs can only navigate one set of data at a time. The ability to access multiple data sources increases the speed of the analytical process and broadens the spectrum of results.

A panhaptic interface according to embodiments allows an analyst to retrieve data from multiple disparate outside data sources to store into a local data storage. Once the data is stored in the local data storage, the analyst can analyze the data as a single data set. Different CSAs may be customized to retrieve data from each individual data source depending on the types of data contained in each individual repository. Once in the local data storage, annotations are produced allowing for restructuring of data from multiple outside data sources at once.

Based on the scenario and data source, a different algorithm may be used to initially structure the data, for example, key value pairing to search for specific terms and combinations of terms. For image and video recognition the analyst can use a computer vision algorithm to interpret the image. For text and number recognition, the analyst can use a natural language processing algorithm. For frequency recognition, the analyst can use a signal-processing algorithm.

### Use Case 3: Training Algorithms

Another embodiment of the present invention is a tool for training algorithms, such as for image and text recognition, during the process of data navigation. The training algorithm embodiment allows the user to allocate certainty levels to the results.

Using the concept of narrower and narrower search queries, the user creates algorithms to find data corresponding to desired attributes including, but not limited to, patterns, inconsistencies, specific images, or objects and actions. The algorithm then filters and annotates data that comes within a given query.

The user is then able to provide confidence levels of the annotations produced by any given algorithm. The rating system allows for training the algorithm to produce more accurate results.

By way of example, if the user is searching an image repository for a red t-shirt with a specific logo, three separate algorithms could be trained to filter out: (1) the color red, (2) the shape of the t-shirt (through three-dimensional modeling), and (3) the image of the logo. Images within the repository that contain relevant findings would then cause extrusions on the data-sphere to protrude. However, images that contain all three findings would cause extrusions from the data-sphere to protrude in larger, sharper variances. When the analyst views the results, he/she will be given the opportunity to rate the certainty level of each. Such user input is used as feedback for further training and strengthening of the algorithm(s).

### Use Case 4: Video Surveillance in Real Time

Another embodiment of the present invention is a real time video surveillance system that uses tactile feedback to significantly reduce required manpower. Currently, the number of security personnel required to monitor surveillance system is inefficient largely due to a shortage of visual attention span. With the haptic glove and the haptic sphere interface, the user can feel activity from all the video sources on the surface of the virtual object without having to visually monitor the information.

Object recognition algorithms for mining picture repositories and live video feeds require complex algorithm training With a panhaptic controller of embodiments of the present invention, a CSA is designed to recognize specific images, or detect people or actions of interest in parallel to other algorithms. The same image may have any number of annotations depending on CSA or analyst input. If actions of interest are detected, and an extrusion is activated on the data-sphere, the user can then select the particular video feed and extract details concerning an activated video feed. In an embodiment, a computer vision algorithm interprets framed images in the camera video to determine which images meet certain criteria.

In this way, a single security guard can feel the activity of thousands of cameras running thousands of parallel algorithms at once in the palm of his or her hand, without having to visually focus on any of the screens. Thus, the need for hundreds of security personnel or thousands of man-hours to analyze the same camera data is avoided.

### Use Case 5: Video Surveillance Using 3D Models

Another embodiment provides video surveillance and image recognition optimized by training the algorithms with the help of a three-dimensional scanner. Currently, for example, face recognition is contingent on the geometry of the face of interest. Therefore, conventional face recognition techniques require the subject person be looking straight at the camera for confident identification.

In an embodiment, a 3D scanner creates a three-dimensional copy of the object or person or action, from which thousands of images are exported from each angle offered by the implemented 3D model. The algorithm is then trained to detect images of faces of interest at many angles within the video repository or live video feeds. Anytime this object or person or action, at any angle or position, appears in any video frame or image, the algorithm will detect it. For video surveillance, a computer vision algorithm is used to interpret framed images within the video.

Algorithms are trained to find actions by creating an animation from the three-dimensional model and taking thousands of images of each potential position within the animation. For example, if detecting acts of violence, the three-dimensional model can be animated to hit or stab another three-dimensional model. Images from every angle of the entire animation are extracted to train the algorithms, and anytime these images are detected in sequence on any camera, the video feed will be annotated with acts of violence.

With the panhaptic interface of an embodiment, thousands of cameras and algorithms can be monitored simultaneously. With the haptic glove and the haptic sphere interface, each video feed is represented by a subdivision in the haptic sphere. The user can feel activity from all the video sources on the surface of the haptic sphere. That is, the user can feel extrusions activated by any subdivision video feed responsive to a particular query. The user can then select the particular video feed underlying an extruded subdivision and identify the objects, persons, or actions involved.

### Use Case 6: Interactive Video Platform for Media and Music Industry

In another embodiment, an application for the media and music industry that allows thousands of live or recorded video feeds to be streamed and haptically navigated simultaneously.

Currently, the media and music industry platforms for viewing video feeds allow viewers to experience one video at a time as well as a list of videos. This list is limited to the viewing page, and therefore no more than a dozen videos can be presented at once.

An embodiment of the panhaptic interface allows for thousands of videos to be streamed simultaneously. The embodiment allows a user to navigate, search, and structure video media through sounds, frequencies, and images. The user may determine similarities between video media across thousands of videos simultaneously. Using a haptic glove allows the user to feel patterns and commonalities of interest in the streamed video data.

Based on the video and interest of the user, a different algorithm may be used to structure the data within videos, for example, key value pairing to search for specific terms and combinations of terms. For image and video recognition the analyst will use a computer vision algorithm to interpret the image. For text and number recognition, the analyst will use a natural language processing algorithm. For frequency recognition, the analyst will use a signal-processing algorithm.

### Use Case 7: Applications for Trading Platforms

Another embodiment provides financial analysis using tactile feedback that allows a user to navigate real-time, high-level, market and banking activity. In the financial analysis embodiment, algorithms are trained to crawl the Internet for market activity such as news articles, values from stock exchange outputs, public company newsletters, or filed registration statements and periodic reports through the SEC's (Securities and Exchange Commission) EDGAR (Electronic Data Gathering, Analysis and Retrieval) open API (Application Programming Interface). The crawlers archive information and links over a period of time in the form of annotations, which are then queried and represented by the heights of the extrusion. Similarly, repositories from bank activities could also be crawled to detect patterns and inconsistencies in financial transactions. Thus, one configuration of this application could be used, for example, by the headquarters of a particular bank looking at activities from all its branches as well as a federal entity looking at activities of all publicly traded banks. In addition to, or in lieu of web crawlers, embodiments can be programmed to use APIs of websites that provide financial data. In an embodiment, natural language processing algorithms are used to analyze data collected during web crawls or API interactions.

Another example is an investment firm with interest in tracking a collection of stocks in a rapidly changing market environment. Each stock is represented as a subdivision in the haptic sphere and when information relative to that stock is detected the subdivision is extruded. This information can include public opinions from large buyers or sellers, public transactions of other trading platforms, and other related market activity that includes any of the stocks in the collection.

A broader configuration could be designed to incorporate the use of multiple virtual objects. For example, in an embodiment, three separate haptic spheres could be configured to represent the NASDAQ stock exchange, the European Stock Exchange, and the New York Stock Exchange, all three of which could be monitored simultaneously by a single analyst.

### Use Case 8: Navigation for DNA Image Sequencing

Another embodiment is an application for navigating DNA image sequencing results by allowing medical analysts to visualize thousands of potential genes of interest at once. Medical analysts working with DNA image sequencing technology have an overwhelming amount of data to process. If one person has over 20,000 genes and each gene has over one million basis pairs, comparing multiple genes between multiple people becomes extremely challenging and time consuming.

Use of a panhaptic interface as described herein allows a medical analyst to view and restructure DNA image sequencing results at a faster pace by visualizing millions of gene combinations in one screen. In a DNA processing embodiment, the three-dimensional object, for example, the haptic sphere is subdivided and linked to thousands and potentially millions of DNA image sequencing results. The DNA imaging sequencing results are annotated by the image sequencing technology. In an embodiment, natural language processing algorithms will be used to crawl the DNA sequencing results for relevant linear nucleotide order combinations of interest.

The analyst may develop and train a CSA to look for a specific combination of linear nucleotide order within millions of sequencing results. The analyst may also navigate and restructure the multiple sequencing results with additional annotations to narrow down data elements having specific gene combinations of interest with exponentially more efficiency than conventional methods.

### Use Case 9: Real-Time Haptic Navigation for the Visually Impaired

Another application for a panhaptic-based data processing system according to an embodiment of the present invention is applicable to visually impaired persons. Such an application would allow visually impaired persons to navigate digital content, such as the Internet in real time using tactile feedback in the form a virtual haptic Braille.

Currently, visually impaired individual are limited to sounds and voice activation to source through digital content in real time. Braille printing delays navigation and produces an excess of wasted material.

Using a panhaptic interface according to an embodiment, visually impaired individuals will have access to the ever-changing and vast information available on the Internet, as languages such as Braille can be adapted to the virtual three-dimensional object to be navigated with a haptic glove. In the case of a Braille based search system, the Braille language is applied to the data object much like a virtual tablet. This allows the user to haptically feel text within different web pages. Typing in different queries, or using voice activation, the user can look up alternate topics, while haptically feeling entire articles or portions of interest and seamlessly traverse web pages. In an embodiment, natural language processing is used to crawl the Internet for relevant text and numbers relating to the information of interest.

As the Braille reader interacts with the virtual three-dimensional object, new content is retrieved from the data source and converted into Braille. Braille-to-three-dimensional model conversion algorithms are used to express the Braille in the virtual haptic object. In an embodiment, an algorithm is programmed to first translate every word in the articles into a virtual Braille language. A second algorithm is programmed to place the virtual Braille on the surface of a virtual three-dimensional object according to the reader's interaction with the object, thus converting any text found in the Internet into virtual haptic Braille.

### Use Case 10: Data Navigation for Education and Research

Another embodiment is an educational application for students, teaching professionals, and researchers to haptically navigate high level Internet activity and allow for faster information intake across multiple subjects. Students will be able to rapidly make connections across the Internet that allow for multi-layered understanding as the students navigate the specified data inputs for a given subject. This application will also allow teaching professionals to structure specific subjects for students to rapidly browse and generate their own annotations and structuring mechanism. Students will be able to correlate information between many concepts and produce high-level hypothesis more efficiently than any method currently available.

To illustrate, in the subject of world history, each subdivision in the virtual object could be set to represent a war in history, from Ancient Greek Wars to Post-Cold War eras. Based on the various queries made, the crawlers would then search thousands of sources on the Internet for information on each specified war, and create a repository of annotations that could include geographic location, number of deaths, weather conditions, parties involved, resources available, etc. Information intake at this level, using parallel encoding neural pathways, is known to accelerate memory recall and inherent understanding of the subject at hand. See, e.g., Klatzky, R. L., & Lederman, S., “There's more to touch than meets the eye: The salience of object attributes for haptics with and without vision,” JOURNAL OF EXPERIMENTAL PSYCHOLOGY VOL, 116, No. 4, 356-369 (1987), which is incorporated by reference herein in its entirety. Ultimately, education at the speed and feel of video games will elevate enthusiasm and interest for learning.

A combination of natural language processing algorithms and computer vision algorithms will be used to crawl the Internet for relevant text, numbers, and images relating to the educational information of interest.

### Use Case 11: Interactive Journalism

In another embodiment, a panhaptic interface is a tool for high-level journalism to navigate the Internet and social media in real time and track multiple topics of interest in parallel.

As information is embedded in the Internet through virtually endless sources, the journalist will be able to haptically feel this movement over time. Similar to the education application of use case 10 above, journalists can research specific subjects, individuals, companies, and global news, with the haptic interface. For example, crawler algorithms could be configured to search the Internet over a specified time frame and to annotate selected components of interest. Thereafter, the journalist can feel and access relevant activity related to the subject matter at hand. The haptic glove allows the journalist to feel high-level information and search results while using vision to examine specific text of interest. The analyst may also export relevant information in the form of diagrams, maps, and spreadsheets. The journalist could create networks of information and narrower queries to produce their report more efficiently than any method currently available.

A combination of natural language processing algorithms and computer vision algorithms will be used to crawl the Internet for relevant text, numbers, and images relating to the journalistic information of interest.

### Use Case 12: Interactive Law Research

In another embodiment, a panhaptic interface is a tool for attorneys and research assistants to conduct high-level research, navigate law libraries on the Internet, and law-related platforms, such as Westlaw or Lexis, to track and cross-examine thousands of legal cases at once.

There are millions of new legal cases filed every year, which makes it very difficult for attorneys to source through potentially relevant information. Similar to the journalism application use case 11 above, attorneys can research specific cases, individuals, companies, and law modifications, with the haptic interface. For example, crawler algorithms could be configured to search legal repositories for specific circumstances within legal procedures. The haptic interface allows the attorney or research assistant to haptically feel high-level information and cross-examine thousands of search results at once, while using vision to focus on specific cases of interest. The attorney could narrow down to relevant information that would directly affect his or her case in a much faster and efficient way than any method currently available.

A combination of natural language processing algorithms and computer vision algorithms will be used to crawl the Internet for relevant text, numbers, and images relating to the legal information of interest.

### Use Case 13: Reputation Management

Application for individuals or businesses to track potential brand reputation problems and opportunities, by managing all media sources containing comments, reviews, complaints, and general feedback, in one interface.

Currently individuals and businesses have entire departments searching within social media to find relevant information about their business. The current method requires many individuals in order to cover all the media available in real time.

The panhaptic interface described herein allows individuals and businesses to consolidate all the media sources in a single visualization. The custom search algorithm retrieves relevant data relating to their brand from multiple outside sources for the individual and businesses to navigate and structure. This reduces the manpower required to source and cross-examine multiple media sources, as well as the reaction time to correct or benefit from the information available.

A combination of natural language processing algorithms and computer vision algorithms will be used to crawl the Internet for relevant text, numbers, and images relating to reputable information relating to specific individuals and business brands.

### Use Case 14: Sustainable Real Estate Application

Another embodiment uses a panhaptic interface in an application for monitoring multiple building systems that measure energy production and usage, water collection and re-distribution, waste management, occupancy, expenses, income, pedestrian circulation, and other components of building operating systems.

Different facets of a city's infrastructure are currently monitored by separate entities. For example, FPL measures electricity in Florida; Water Management is responsible for water use; and Waste Management is responsible for the disposal of waste and recycling material. However, with the advances in water collection, solar panels, wind turbines, and composting systems, urban development is rapidly moving towards energy-producing assets and consequently, reducing the use of, and reliance on, outdated and outmoded city infrastructures. Such decentralization of city-based control of resources and waste management systems will require new applications for monitoring operations.

Using a panhaptic-based interface as described herein, interested parties can efficiently monitor or navigate relevant historical information, as well as real-time information in parallel, using the haptic sphere and haptic glove. For instance, real estate developers, managing companies, and REITs (Real Estate Investment Trusts) could monitor portfolios of real property assets through virtual three-dimensional objects that resemble the particular assets to detect operational patterns to optimize efficiency and sustainability.

In an embodiment, natural language processing algorithms are used to crawl the Internet for relevant text and numbers relating to the real estate market, and public sources with data archives on natural resources and waste management.

Use Case 15: Structuring Data with EEG Technology

Another embodiment provides a panhaptic interface for structuring data repositories using electroencephalography (EEG) to seamlessly annotate information. In this application, annotations are reflected in the haptic sphere and the user interface for immediate analysis. The user receives input from the haptic glove, views the original source of the data, and feeds back through the electrical activity recorded when reacting to the data. A seamless bidirectional loop is facilitated through neural oscillations rather than keyboard entries or voice activation allowing the speed of structuring data to exponentially increase.

The user can annotate data with an EEG controller in multiple ways. For example, a user looking for weapons within an image repository would view a series of images displayed at high speeds. Whenever the specified weapon appears, the user reacts, brain activity is detected, the EEG controller captures the reaction and the image is tagged with a weapon annotation. The user's EEG response when seeing a specified weapon can be obtained in a controlled environment. The stored response then becomes a standard against which the user's EEG response when viewing live data is compared. A match indicates the presences of the specified weapon. Machine learning can be employed to further determine the user's EEG response to a particular stimulus or stimuli.

Another example is parsing information of interest without a specific query or focus. The user is presented with a series of images from a repository of unknown data. Any data, regardless of its content, can be selected, annotated, and archived separately for further analysis. This way, before knowing what to look for, the user can quickly narrow down groups of potentially valuable information.

Based on the scenario, a different algorithm may be used to structure the data, for example, key value pairing to search for specific terms and combinations of terms. For image and video recognition the analyst will use a computer vision algorithm to interpret the image. For text and number recognition, the analyst will use a natural language processing algorithm. For frequency recognition, the analyst will use a signal-processing algorithm.

Use Case 16: Training Algorithm with EEG Technology

In another embodiment, use of a panhaptic interface provides for training algorithms using electroencephalography to measure neural oscillation and assign confidence levels during the training process.

Structuring data with EEG technology allows for automatic rating of confidence levels in query results. The user is presented with a series of query results and instructions to detect, for example, results that are highly accurate and results that are false positives. Similar to use case 14, the algorithm will recalibrate from real feedback from the user and adjust annotations accordingly such as deleting annotation that are not found highly accurate. The algorithm's confidence levels will rise and the queries will become increasingly accurate.

### Use Case 17: Interactive Virtual Music Instrument

Another embodiment provides applications for virtual musical instruments to allow musicians access to thousands of sounds in a single visualization. Using frequency recognition though signal-processing algorithms, musicians can retrieve sound samples within the Internet and store them in the local data storage. Using haptic gloves, musicians and music enthusiast can play and combine thousands of sounds using their fingers and hands as they would a physical music instrument such as a piano or flute. The combination of virtual display and haptic interface allows for interaction in musical composition beyond any method currently available.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed:

1. A system for mining data from a Big Data data set, comprising:
a user interface through which a user enters a query comprising one or more search terms to query one or more outside data sources containing the Big Data for data responsive to the query;
a visualization module to generate a three-dimensional representation of the responsive data, wherein the three-dimensional representation is divided into subdivisions with one subdivision corresponding to each data element in the responsive data, and wherein the visualization module generates one or more extrusions that reflect how relevant data underlying each extruded subdivision is to the query; and
an interface to present the three-dimensional representation of the responsive data generated by the visualization module.

2. The system recited in claim 1, further comprising a local data storage into which data responsive to the query is stored.

3. The system recited in claim 2, further comprising one or more annotations stored with each data element in the data responsive to the query.

4. The system recited in claim 3, wherein each data element has an original data ID, and each annotation is associated with one or more original data IDs to link each annotation to one or more data elements.

5. The system recited in claim 3, wherein each annotations has an annotation ID, and each data element in the responsive data is association with one or more annotation IDs to link each data element to one or more annotations.

6. The system recited in claim 1, further comprising an extrusion parameter configuration interface to allow a user to configure the appearance of the extrusions.

7. The system recited in claim 1, further comprising:
a haptic glove; and
a panhaptic interface to control the haptic glove, wherein the haptic glove allows the user to feel the extrusions.

8. The system recited in claim 7, wherein the haptic glove allows a user to feel the shape of an extrusion.

9. The system recited in claim 7, wherein the haptic glove allows a user to feel the sharpness of an extrusion.

10. The system recited in claim 1, wherein the top of an extrusion identifies an outside data source from where at least a portion of the data underlying the extrusion originated.

11. The system recited in claim 1, wherein the top of an extrusion identifies at least one search term.

12. A method for mining data from a Big Data data set, comprising:
entering a query comprising one or more search terms to query one or more outside data sources for data responsive to the query;
generating a three-dimensional representation of the responsive data;
dividing the three-dimensional representation of the responsive data into subdivisions with one subdivision corresponding to each data element in the responsive data;
generating one or more extrusions that reflect how relevant data underlying each extruded subdivision is to the query; and
presenting the three-dimensional representation of the responsive data generated by the visualization module.

13. The method recited in claim 12, further comprising storing the responsive data into a local data storage.

14. The method recited in claim 13, further comprising storing one or more annotations stored with each data element in the data responsive to the query.

15. The method of claim 14, further comprising:
assigning each data element an original data ID; and
associating each annotation with one or more original data IDs to link each annotation to one or more data elements.

16. The method of claim 14, further comprising:
assigning an annotation ID to each annotation; and
associating each data element in the responsive data is association with one or more annotation IDs to link each data element to one or more annotations.

17. The method recited in claim 1, further comprising providing a panhaptic interface that controls a haptic glove, wherein the haptic glove allows the user to feel the extrusions.

18. The method recited in claim 12, further comprising identifying an outside data source from where at least a portion of the data underlying the extrusion originated with the top of an extrusion.

19. The method recited in claim 12, further comprising identifying at least one search term with the top of an extrusion.
